(19) United States
(12) Patent Application Publication
(10) Pub. No.: US 2018/0289571 A1
(43) Pub. Date: Oct. 11, 2018

(54) Air Assisted Lateral Patient Transfer Device

(71) Applicant: Douglas S. Keith, Golf, FL (US)

(72) Inventor: Douglas S. Keith, Golf, FL (US)

(21) Appl. No.: 15/898,422

(22) Filed: Feb. 17, 2018

Related U.S. Application Data
(60) Provisional application No. 62/459,671, filed on Feb. 16, 2017.

(51) Int. Cl. A61G 7/10

(52) U.S. Cl. CPC A61G 7/1028; A61G 7/1026

(57) ABSTRACT

An air assisted lateral patient transport system that uses a semi-permeable fabric with a uniform air permeable surface on the bottom layer of the plenum. The semi-permeable fabric provides lift to assist moving patients, and allows cleaning solutions to enter the device for cleaning. The patient transfer device allows independent control of air pressure in each air chamber such that air pressure can be dynamically modified to avoid bed sores and other blood circulation related problems during transport. In addition, a unique patient restraint strap is employed that eliminates buckles for patient safety and comfort. The multi chambered patient transport system 1 provides a support surface on which to receive a patient, easily move the patient, and provide air pressure controls to avoid bed sores during transport and while being treated at a medical facility. The system includes a plurality of independent air chambers to independently control air pressure in each air chamber.

### CROSS-REFERENCE TO RELATED APPLICATIONS

This application is related to, and claims the benefit of, the provisional patent application entitled “Air Assisted Lateral Transfer Device For Patients”, filed Feb. 16, 2017, bearing U.S. Ser. No. 62/459,671 and naming Douglas S. Keith, the named inventor herein, as sole inventor, the contents of which is specifically incorporated by reference herein in its entirety.

### BACKGROUND OF THE INVENTION

### Technical Field

The invention is related to patient transport systems. In particular, it relates to an air assisted lateral transfer device that supports a patient during transport to a medical facility and/or within the medical facility.

### Background

Prior art air assisted lateral transfer devices typically use two similarly shaped layers of fabric joined together to form a plenum chamber for air retention. Typically, the bottom layer of the plenum is perforated with holes that produce a friction-reducing layer of air beneath the device when pressurized air is supplied to the plenum chamber. As a result, the patient is more comfortable during transport, and importantly, the physical exertion of medical personnel is reduced when transferring patients. This is especially useful when transferring bariatric patients.

Current prior art air assisted lateral transfer device production techniques include attaching a top layer and a bottom layer of coated fabric to create an air chamber. The method of attachment can be direct or can include the use of an intermediate side panel. The pieces can be sewn or welded together by any suitable method. The top layer is generally referred to as the patient surface. The bottom layer contains holes through which pressurized air escapes. This creates a Reduced Friction Zone under the device that allows it to be moved with reduced effort. As noted above, this is a benefit to both the patient and the medical personnel who are moving the patient.

The prior art production process includes multiple time-consuming and costly steps. For example, the holes in the bottom layer are individually created in a size and pattern that is designed to meet the needs of the device. It is a time consuming process in that each hole is drilled in the fabric either mechanically or electronically. The hole drilling process creates inefficiencies in the manufacturing process. It would be desirable to have a simpler construction process that would reduce the time needed to fabricate the device as well as reducing costs.

Currently available air assisted lateral transfer devices use a fabric coated with a layer of PVC, Urethane or other suitable coating to make the plenum chamber airtight. However, access to the plenum chamber during laundering is limited by the materials and design used to fabricate the device. The current materials reduce the ability of cleaning and disinfection chemicals to enter the device and are restricted because they have to pass through the punched holes in the bottom layer. It would be desirable to have an effective way to clean the device because it will be used with subsequent patients.

Another problem associated with the prior art is that patients may be required to spend considerable time during transport to a hospital. During this time, bed sores, or pressure ulcers, may occur when a patient is bed ridden or inactive for a long period of time, causing parts of the body that are in contact with the mattress or patient surface to be constantly subjected to pressure. This results in obstructed blood flow, which can damage the affected tissue and ultimately leads to bed sores.

In hospitals, patients who are deemed to be at risk of developing a pressure related bed sore are generally provided with an alternating pressure mattress. Such mattresses typically include a plurality of inflatable transverse cells divided into two or more groups of cells, which groups of cells are cyclically inflated and deflated.

In addition to pressure, friction and shear are mechanical forces which can cause pressure ulcers. Friction and shear injuries require movement and commonly occur when moving or repositioning patients. Friction is the mechanical force exerted when skin is dragged across a coarse surface such as bed linens. Shear is deep tissue injury where the deeper fascia slides downward and the superficial fascia remains attached to the dermis. These forces can result in cellular death and tissue necrosis.

In practice the process of transitioning from a patient transfer device, such as a gurney, to an alternating pressure mattress requires manual manipulation of the patient by the nursing staff and potential discomfort or damage to the patient. During long periods of inactivity such as are prevalent in long surgical procedures it may not be practical or efficient to maintain multiple devices under the patient.

It would be desirable to have a patient transport device that includes the ability of alternate pressure such that that bed sores could be avoided.

While the prior art has provided a variety of patient transport systems, it has failed to provide a system that generates a uniform air cushion across the bottom of the device such that the device can be easily moved. In addition, it has failed to provide transport device that would avoid patient bed sores. Further, it has failed to provide an efficient method of cleaning the device, which is very important when transporting patients that may have any kind of ailment.

### SUMMARY OF THE INVENTION

The present invention provides an air assisted lateral patient transfer device that uses a semi-permeable fabric that has a uniform air permeable surface on the bottom layer of the plenum. In addition, a unique patient restraint strap is employed that eliminates buckles for patient safety and comfort. The semi-permeable fabric uses micro perforated nylon fabric that allows air to pass through.

### BRIEF DESCRIPTION OF THE DRAWINGS

FIG. 1A is a top view of the patient transport system using a transparent upper surface.

FIG. 1B is a bottom view of the patient transport system using an air permeable bottom surface.

FIG. 2 is top view of an alternative embodiment of the patient transport system.

FIG. 3 is a top view of the patient transport system showing the top layer of the plenum.

FIG. 4 is a bottom view of the patient transport system showing the air permeable surface on the bottom layer of the plenum.

FIG. 5 is a perspective view of the patient transport system showing an alternative embodiment of the invention in which an inflatable bolster the extends around the periphery of the patient transport system Longworth venture baffles.

### DESCRIPTION OF THE PREFERRED EMBODIMENT

Prior to a detailed discussion of the figures, a general overview of the invention will be presented. The invention provides an air assisted lateral patient transfer device that uses a semi-permeable fabric which has a uniform air permeable surface to replace the fabric bottom layer used in the conventional construction of the prior art. An important advantage provided by this invention is the improved method of creating the airflow holes in the bottom layer of the device.

The benefits of this method of construction include the elimination of the time-consuming laser hole drilling procedure from the manufacturing process, improvement in the laundry and disinfecting process used for cleaning and reprocessing of these products, and the enhancement of the performance characteristics of the transfer device.

The upper and lower plenums of the patient transport device can be attached to one another in any suitable manner, such as adhesives, heat welding, chemical welding, RF welding, stitching, etc.

An additional and novel design enhancement of the invention is the unique Patient Restraint Strap (“PRS”). The PRS eliminates plastic buckles, an issue in patient safety and skin integrity, through the use of hook and loop fasteners and also acts as a retention strap to fasten the device to a transfer surface such as a bed or gurney when not in use.

The invention provides a significant improvement over laundry and disinfection processes because of the semi-permeable fabric used in its construction. While the prior art designs use a fabric coated with a layer of PVC, Urethane or other coating to make the plenum chamber airtight, they also make it difficult for cleaning solutions enter the device. Access to the plenum chamber during laundering is limited to passing cleaning and disinfection chemicals through the punched holes in the bottom layer. The use of a semi-permeable fabric as the bottom layer allows for a uniform saturation of the bottom layer during laundering. The uniform saturation of the bottom layer increases the ability of disinfectants to reach all areas of the air chamber thus enhancing the sanitization process. Given the variety of medical contaminants that patients are exposed in medical facilities, it is important that items that come in contact with the patient are clean. The fabric used by this invention accomplishes that goal better than the prior art.

A preferred embodiment of the invention uses a top and bottom layer connected by a side panel that extends down both sides and around the head end of the mattress. The use of a side panel differs from current disposable mat designs that specify a single perimeter seam. Other commercially available products use a side panel that extends down the sides but does not encompass the head end of the device. The instant invention extends the side panel around the head end. By so doing, it allows the patient's head position to be adjusted from level to a slightly elevated position. This provides significantly more flexibility when attempting to make the patient comfortable. The use of both side and head end side panels also allows the bottom layer to be positioned to be in better contact with the transfer surface thus enhancing the development of the Reduced Friction Zone air film under the device.

Another advantage of the invention is that while many prior art devices place air apertures in the bottom layer holes near the center area of the mat while keeping the side chambers, or bolsters, free of holes. This invention uses a semi-permeable fabric, rather than apertures, that allows air to escape uniformly in greater areas of the side and bottom. This extension of the Reduced Friction Zone reduces the initial effort required to overcome the friction of the device at rest, which makes it easier for medical personnel to move the patient. It also aids in the degassing of the device after use.

Having discussed the features and advantages of the invention in general, we turn now to a more detailed discussion of the figures.

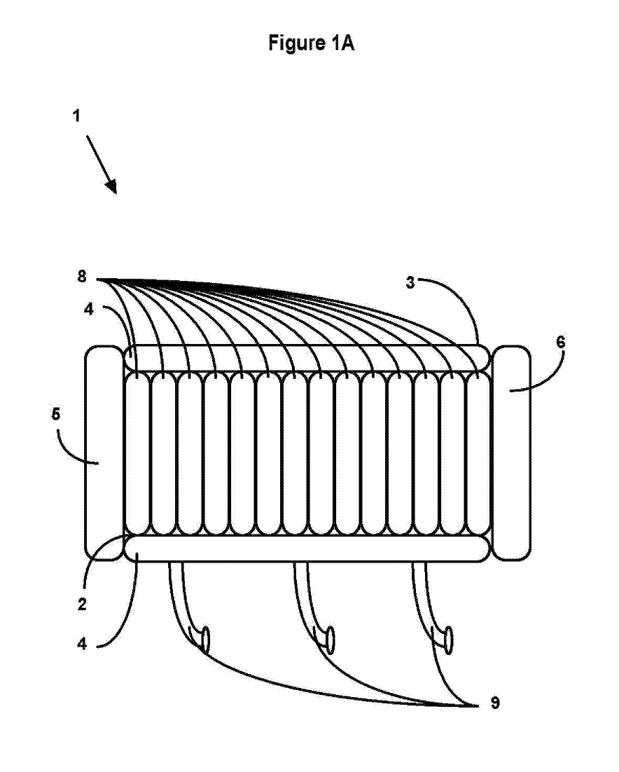

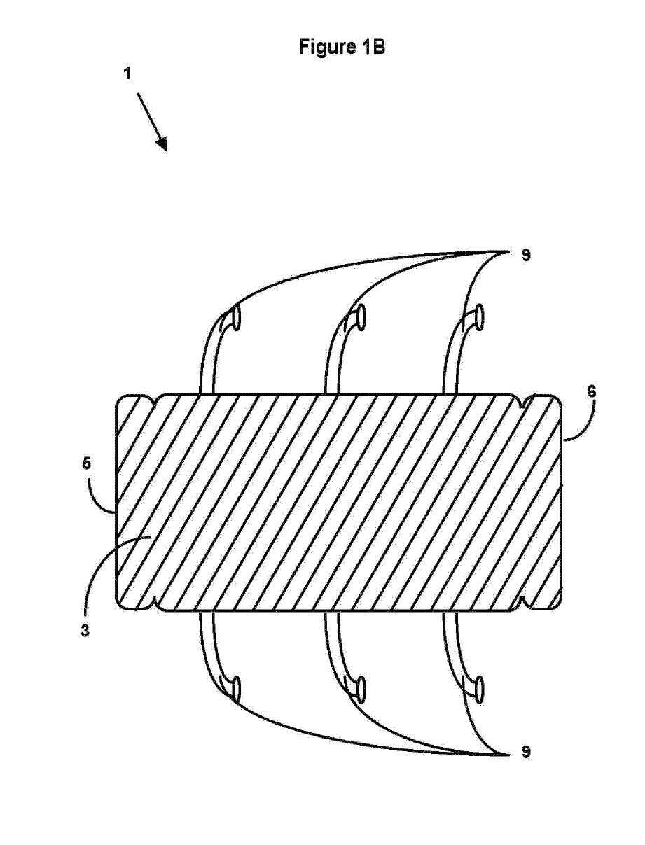

FIG. 1A is a top view of the patient transport system 1 using a transparent upper surface 2. The upper surface 2 is shown in transparent form to illustrate the internal structure of the patient transport system 1. In practice, the upper surface 2 does not have to be transparent. In a preferred embodiment, the patient transport system 1 has a sidewall 4. Also indicated in the drawing is the head section 5 where a patient's head would normally rest, and the foot section 6 which would accommodate the patient's feet.

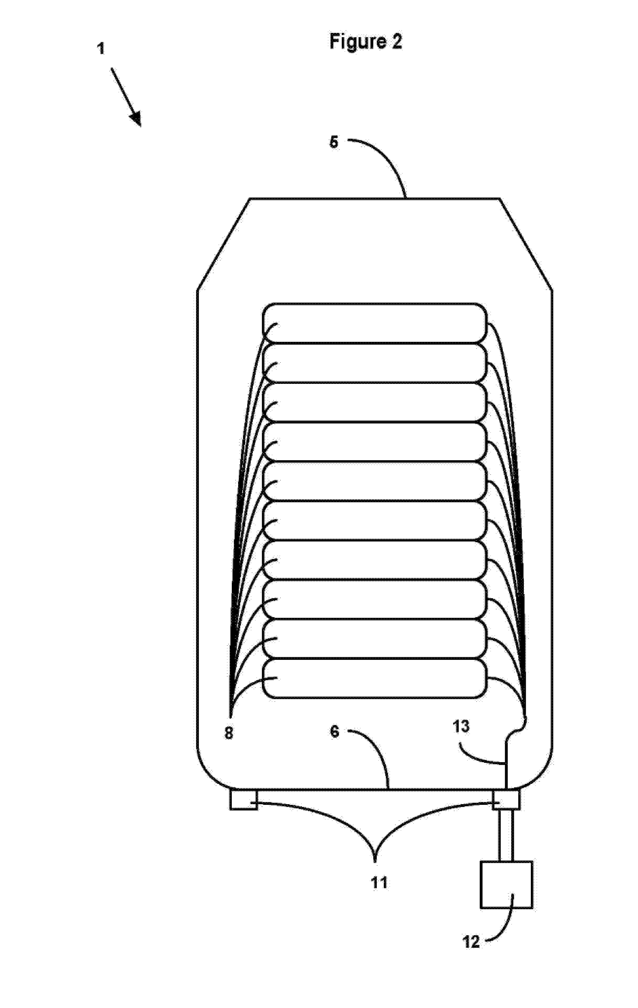

A pressurized air line 7 is also shown in the figure. During use, the pressurized air line 7 is attached to a pressurized air pressure controller/pump 12 (shown in FIG. 2) that can be any suitable commercially available air pressure source.

In a preferred embodiment, the body of the patient transport system 1 is comprised of multiple independent air chambers 8. For ease of illustration, the air chambers 8 are shown as having a uniform shape. However, those skilled in the art will recognize that the air chambers 8 can vary in size, shape, and arrangement. Likewise, they can be connected such that they all have the same air pressure, they can be connected in groups with each group having a predetermined air pressure, or they can be connected such that each air chamber 8 operates independent of the other air chamber 8.

The figure shows the belts 9 that are used to secure the patient transfer system 1 to a cart (not shown), and/or to secure the patient to the patient transfer system 1.

Finally, in this figure the location of the bottom surface of the patient transport system 1 is indicated by the number 3. The bottom surface 3 of this invention this fabricated from air permeable material that allows a portion of the pressurized air to be expelled from the bottom surface of the patient transport system 1. The air forced through the bottom surface 3 creates a cushion of air that reduces the friction of the patient transport system 1 when a patient is being slid from the car to a secondary surface such as a treatment table.

FIG. 1B is a bottom view of the patient transport system 1 showing an air permeable bottom surface 3. Pressurized air escapes through the permeable bottom surface 3 and provides lift to the patient transport system 1. The lift allows a care provider to more easily slide the patient transport system 1 from one location to another. The air cushion provided by the invention provides two advantages. First, it allows the patient to be more comfortably moved and with greater ease. As a result, the patient is less likely to be disturbed or further injured during the move. Second, the medical personnel moving the patient will have less exertion which in turn will place less stress on easily injured parts of their body, such as their back. This is especially useful when moving bariatric patients.

In the preferred embodiment, the permeable bottom surface 3 is a micro perforated nylon fabric that allows air to pass through. Nylon is preferred do to its superior performance in terms of strength and wear characteristics. Those skilled in the art will recognize that the perforations can be made mechanically by punching, or by alternative measures such as laser drilling.

FIG. 2 is top view of an alternative embodiment of the patient transport system 1. In this view, the independent air chambers 8 are shown. In the preferred embodiment, each air chamber 8 is sealed and independently controllable and does not exchange airflow between air chambers 8. Also shown in this figure is air pressure controller/pump 12. Air pressure controller 12 attaches to the patient transport system 1 at input port for 11. Input ports 11 can be located on both sides of the patient transport system 1 for convenience. Air pressure controller 12 controls each air conduit 13 that feeds pressurized air into each air chamber 8. In this embodiment, air pressure controller 12 allows each air chamber 8 to maintain air pressure at varying levels, if desired, to avoid problems such as bedsores. Varying air pressure for this purpose is well known in the art.

A simplified embodiment fabricates air chambers 8 such that there is some airflow between them to equalize pressure. This is a simpler structure that allows the patient transport system 1 to be used as a conventional air mattress.

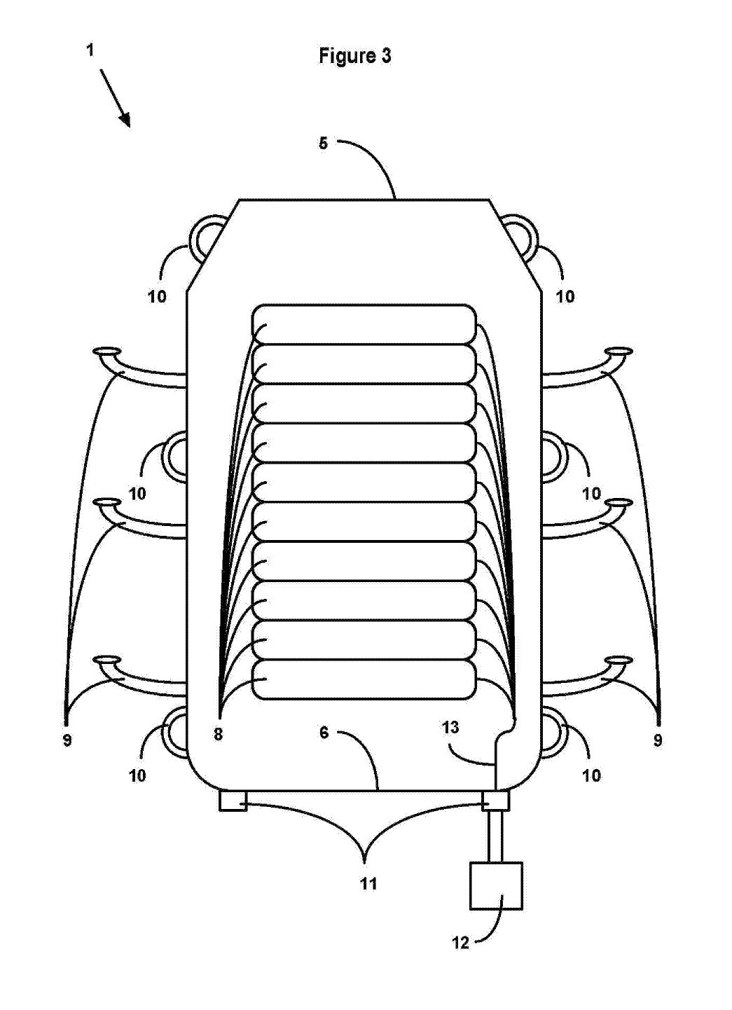

FIG. 3 is a top view of the patient transport system 1. Hand grips 10 are shown near the head section 5, near the foot section 6, and on the sides. The handgrips 10 are used to ensure that the medical personnel have a secure and safe grip on the patient transport system 1 when they are moving the patient from one physical location to another.

This view also shows the straps 9 that can be used to 1) secure the patient to the patient transport system 1, or 2) secure the patient transport system 1 to a gurney or a bed. Those skilled in the art will recognize that the number of straps 9 can vary such that the patient can be simultaneously secured to the patient transport system 1 and to a gurney or a bed. A unique patient restraint strap is used that replaces the standard two patient restraint buckle straps. The buckles on prior art straps are a hazard in the hospital as they get caught in the bed mechanism and can result in patient injuries. This is eliminated by replacing the buckles with hook and loop material. The hook and loop strap, do to its unique design, can be used to secure the patient transport system 1 to the hospital bed or gurney when it is not in use.

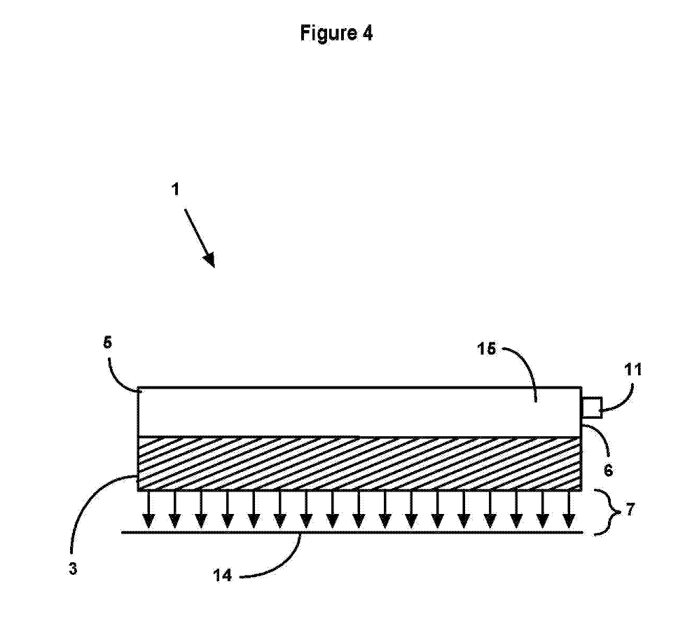

FIG. 4 is a side edge view of the patient transport system 1. This figure illustrates airflow 7 flowing out of air permeable bottom layer 3. The airflow 7 pushes against the surface 14 that the patient transport system 1 rests on. Top layer 15 does not allow air flow through its surface. As a result, medical personnel can more easily slide the patient transport system 1 from one location to another. This helps prevent injuries to medical personnel, and also helps the patients in that they can be more comfortably moved.

Fabrication of the patient transport system 1 uses a technique called drop stitch fabric, to attach the air permeable bottom layer 3 to top layer 15 of the plenum chamber are attached to each other by individual strands of string. This creates a significantly strong structure. For example, the military uses this technique to make floors in inflatable boats. Drop stitch is only able to be used in this application because of the use of the micro perforated nylon. It would be impossible in conventional construction because of the holes. The drop stitch threads replace the use of baffles and allow for a wide range of design shapes.

An important advantage provided by the invention is that it facilitates maintaining the cleanliness of the patient transport system. While prior art systems use a distribution of several apertures, the materials used to fabricate them restricts the flow of cleaning solutions when their devices are being washed. This is a significant disadvantage in a medical environment where any number of unknown contaminants or biological hazards may be present. Since patient transport systems are typically reused, it is vitally important to avoid unintended transmission of contaminants from one patient to the next.

Applicant's invention solves this problem by providing a lower surface that allows a more even entry and distribution of cleaning solutions throughout the inside of the patient transport system. As a result, the air permeable surface on the bottom of the patient transport system 1 allows a) the patient to be more easily moved, b) cleaning fluids to be more easily injected into the patient transport system 1 after use, and c) allows the patient transport system 1 to be more easily drained after cleaning because the air permeable surface on the bottom of the patient transport system allows air out during use, and allows cleaning solutions in during maintenance.

Most important, the improved cleaning method provided by the air permeable bottom surface 3 reduces the chances of contamination or infection to subsequent patients.

In addition, the patient transport system 1 also provides dynamic control over each air chamber 8 such that not only can patients easily moved, but they can also avoid having problems such as bedsores, because air chambers 8 can be independently adjusted to facilitate better blood flow.

The multi chambered patient transport system 1 provides a support surface on which to receive a patient, easily move the patient, and provide air pressure controls to avoid bed sores during transport and while being treated at a medical facility. The multi-chambered air mattress includes a plurality of independent air chambers 8. In the preferred embodiments each air chamber 8 is independently control such that air pressure can be varied in each air chamber 8. Alternatively, the air chambers 8 extending across the mattress constituting a support pad with a plurality of transverse cells arranged generally parallel to one another in a side-by-side arrangement. A first group of inflatable cells are interconnected and inflation or deflation is controlled by an air or fluid pump. Subsequent second or any other group of cells are interspersed among the first group of cells and are also inflated or deflated with an air or fluid pump. The cell groups are alternately inflated or deflated so as to provide a varying level of patient support. An example of a known Alternating Pressure Support Pad is disclosed in U.S. Pat. No. 5,901,393 (Pepe et al).

The patient transport system 1 also has an inflatable plenum, in which the bottom surface provides a plurality of openings to create a cushion of escaping air beneath the chamber. The cushion of air facilitates movement of the entire mattress limiting the patients' exposure to temporary pressure, shear and friction. In the preferred embodiment, the patient transport system 1 has an upper portion consisting of a plurality of air chambers 8 to alternate air pressure for the purpose of avoiding bed sores, and a lower portion in which an inflatable plenum ejects air to facilitate movement of a patient.

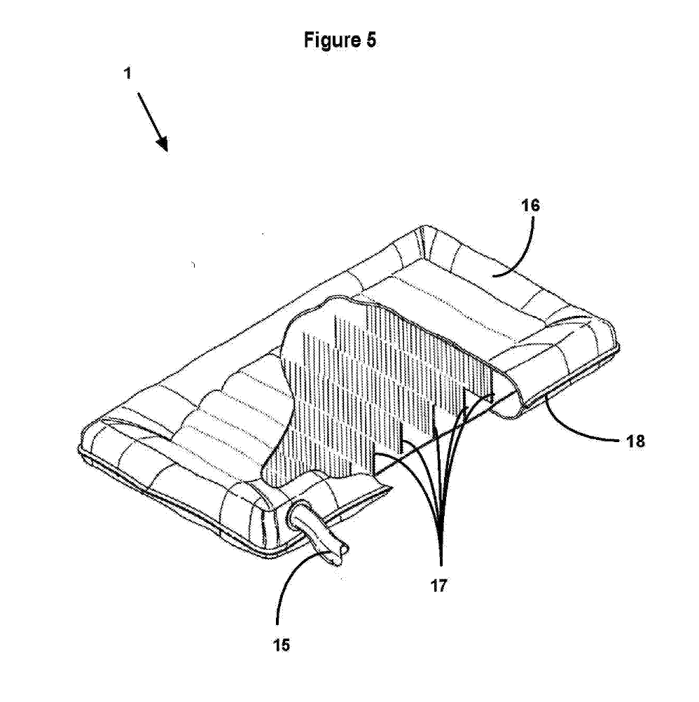

FIG. 5 is a cutaway perspective view of the patient transport system 1 showing an alternative embodiment of the invention in which an inflatable bolster 16 extends around the periphery of the patient transport system 1. In addition, the figure also shows baffles 17 that separate the internal structure of the patient transport system 1 into separate air chambers 8. The figure also illustrates air supply 15 that puts air pressure into the patient transport system 1. Seam 18 is shown extending around the periphery of the patient transport system 1 and is the secured using drop stitch technology.

Providing an inflatable bolster 16 around the edge of the patient transport system 1 allows the medical care providers to raise the head position of the patient. Using the variable speed air supply, Patient's head position can be raised or lowered. This is important to air way management of the patient in the intubation process. In the prior or this would normally done using pillows or cushions or other external devices. The use of adjustable air pressure provides improved position control for the patient. Further, since the patient is already on the patient transport system 1, it is convenient and instantaneous.

While the invention has been described with respect to a preferred embodiment thereof, it will be understood by those skilled in the art that various changes in detail may be made therein without departing from the spirit, scope, and teaching of the invention. For example, the material used to fabricate both the top and the bottom layers can vary, the number of air chamber scan vary, the number of straps can vary, etc. Accordingly, the invention herein disclosed is to be limited only as specified in the following claims.

I claim:

What is claimed is:

1. An air assisted lateral transfer device for patients, comprising:
an inflatable pressurized mat for patient transport, further having:
substantially airtight upper an side surfaces;
an air-permeable bottom surface;
an air input to receive pressurized air, the pressurized air partially escaping through the air-permeable bottom surface such that the escaped air forms an air cushion to reduce friction when the inflatable pressurized mat is moved to transfer a patient.
